(19) United States
(12) Patent Application Publication
(10) Pub. No.: US 2008/0266872 A1
(43) Pub. Date: Oct. 30, 2008

(54) OPTICAL PLATE AND BACKLIGHT MODULE USING THE SAME

(75) Inventor: Shao-Han Chang, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/836,799

(22) Filed: Aug. 10, 2007

(30) Foreign Application Priority Data
Apr. 27, 2007 (CN) 200710200524.5

(51) Int. Cl. F21V 13/04; F21V 5/02; F21V 8/00

(52) U.S. Cl. 362/309; 362/311; 362/333

(57) ABSTRACT

An exemplary optical plate includes at least one transparent plate section. The transparent plate section includes a light output surface, a bottom surface, a plurality of elongated V-shaped protrusions, a plurality of spherical protrusions and at least one lamp-receiving portion. The light output surface is opposite to the bottom surface. The elongated V-shaped protrusions are formed on the bottom surface. The spherical protrusions are formed on the light output surface. The lamp-receiving portion is defined in the bottom surface. A backlight module using the present optical plate is also provided.

### CROSS-REFERENCE TO RELATED APPLICATIONS

This application is related to seven copending U.S. patent applications, which are: application Ser. No. 11/835,425, filed on Aug. 8, 2007, and entitled “OPTICAL PLATE AND BACKLIGHT MODULE USING THE SAME”; application Ser. No. 11/835,426, filed on Aug. 8, 2007, and entitled “OPTICAL PLATE AND BACKLIGHT MODULE USING THE SAME”; application Ser. No. 11/835,427, filed on Aug. 8, 2007, and entitled “OPTICAL PLATE AND BACKLIGHT MODULE USING THE SAME”; application Ser. No. 11/835,428, filed on Aug. 8, 2007, and entitled “OPTICAL PLATE AND BACKLIGHT MODULE USING THE SAME”; application Ser. No. 11/835,429, filed on Aug. 8, 2007, and entitled “OPTICAL PLATE AND BACKLIGHT MODULE USING THE SAME”; application Ser. No. 11/835,430, filed on Aug. 8, 2007, and entitled “OPTICAL PLATE AND BACKLIGHT MODULE USING THE SAME”; application Ser. No. 11/835,431, filed on Aug. 8, 2007, and entitled “OPTICAL PLATE AND BACKLIGHT MODULE USING THE SAME”. In all these copending applications, the inventor is Shao-Han Chang. All of the copending applications have the same assignee as the present application. The disclosures of the above identified applications are incorporated herein by reference.

### BACKGROUND OF THE INVENTION

1. Field of the Invention

The present invention relates to an optical plate for use in, for example, a backlight module, the backlight module typically being employed in a liquid crystal display (LCD).

2. Discussion of the Related Art

In a liquid crystal display device, liquid crystal is a substance that does not itself radiate light. Instead, the liquid crystal relies on light received from a light source to display images and data. In the case of a typical liquid crystal display device, a backlight module powered by electricity supplies the needed light.

FIG. 14 represents a typical direct type backlight module 100. The backlight module 100 includes a housing 11, a light reflective plate 12, a light diffusion plate 13, a prism sheet 14, and a plurality of light emitting diodes 15 (hereinafter called LED). The housing 11 includes a rectangular base 111 and four sidewalls 113 extending around a periphery of the base 111. The base 111 and the four sidewalls 113 cooperatively define a chamber 115. Each LED 15 includes a base portion 153 and a light-emitting portion 151 disposed on the base portion 153. The LEDs 15 are electrically connected to a printed circuit board 1 6, and the printed circuit board 16 is fixed to the base 111 of the housing 11. The light reflective plate 12 is disposed on the LEDs 15 in the chamber 115. The light reflective plate 12 defines a plurality of through holes (not labeled) that allow the light-emitting portions 151 of the LED 15 to pass through and to emit light to be transmitted the light diffusion plate 13. The light diffusion plate 13 and the prism sheet 14 are stacked in that order on the chamber 115. Light emitted from the LEDs 15 is substantially reflected by the light reflective plate 12 to enter the light diffusion plate, and diffused uniformly in the light diffusion plate 13, and finally surface light is outputted from the prism sheet 14.

Generally, a plurality of potential dark areas may occur because of the reduced intensity of light between adjacent LEDs 15. In the backlight module 100, each LED 15 further includes a reflective sheet 157 disposed on the top of the light-emitting portion 151, configured for decreasing the brightness of a portion of the backlight module 100 above the LED 15. However, the brightness of the backlight module 100 is not uniform. One method of enhancing the uniformity of brightness of the backlight module 1 00 is to increase a space between the light diffusion plate 13 and the LEDs 15. This increasing space tends to eliminate potential dark areas. However, increasing the space between the light diffusion plate 13 and the LEDs 15 will also increase the thickness of the backlight module 100, and the further overall intensity of the output light is reduced.

What is needed, therefore, is a new optical plate and a backlight module using the optical plate that can overcome the above-mentioned shortcomings.

### SUMMARY

An optical plate according to a preferred embodiment includes at least one transparent plate section. The transparent plate section includes a first surface, a second surface, a plurality of elongated V-shaped protrusions, a plurality of spherical protrusions and a lamp-receiving portion. The second surface is opposite to the first surface. The elongated V-shaped protrusions are formed on the first surface. The spherical protrusions are formed on the second surface. The lamp-receiving portion is defined in at least one of the first surface and the second surface.

A backlight module according to a preferred embodiment includes a housing, a side-lighting type point light source, an optical plate, and a light diffusion plate. The housing includes a base and a plurality of sidewalls extending from a periphery of the base, the base and the sidewalls cooperatively forming an opening. The point light source is disposed on the base, and has a light-emitting portion. The same optical plate as described in the previous paragraph is employed in this embodiment. The light-emitting portion of the point light source is inserted in the lamp receiving portion of the optical plate correspondingly. The light diffusion plate is disposed on the housing over the opening.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and backlight module. Moreover, in the drawings, like reference numerals designate corresponding parts throughout several views, and all the views are schematic.

FIG. 1 is a side cross-sectional view of a backlight module using an optical plate according to a first preferred embodiment of the present invention.

FIG. 2 is an enlarged view of a circled portion II of FIG. 1.

FIG. 3 is an isometric view of the optical plate of FIG. 1.

FIG. 4 is similar to FIG. 3, but viewed from another aspect.

FIG. 5 is a side cross-sectional view taken along line V-V of FIG. 3.

FIG. 6 is an isometric view of an optical plate according to a second preferred embodiment of the present invention.

FIG. 7 is similar to FIG. 6, but viewed from another aspect.

FIG. 8 is a cross-sectional view taken along line VIII-VIII of FIG. 6.

FIG. 9 is a side cross-sectional view of an optical plate according to a third preferred embodiment of the present invention.

FIG. 10 is a side cross-sectional view of an optical plate according to a fourth preferred embodiment of the present invention.

FIG. 11 is a top plane view of an optical plate according to a fifth preferred embodiment of the present invention.

FIG. 12 is a top plane view of an optical plate according to a sixth preferred embodiment of the present invention.

FIG. 13 is a top plane view of an optical plate according to a seventh preferred embodiment of the present invention.

FIG. 14 is a side cross-sectional view of a conventional backlight module.

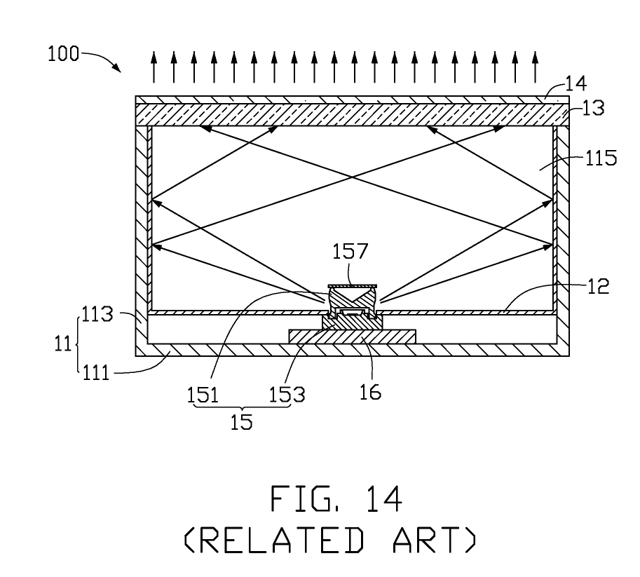

### DETAILED DESCRIPTION OF THE PREFERRED EMBODIMENTS

Reference will now be made to the drawings to describe preferred embodiments of the present optical plate and backlight module, in detail.

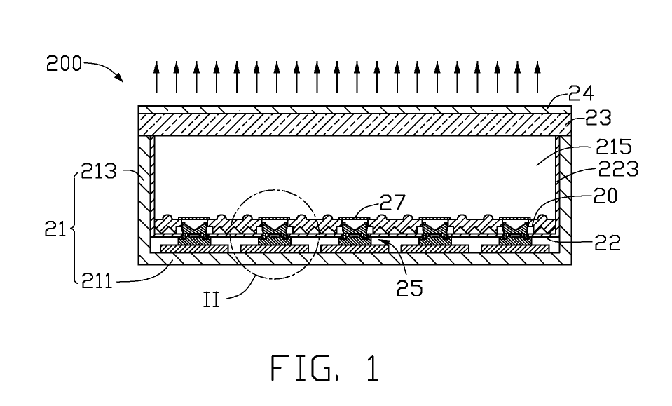

Referring to FIG. 1, a backlight module 200 in accordance with a first preferred embodiment is shown. The backlight module 200 includes a housing 21, a light reflective plate 22, a light diffusion plate 23, a plurality of side-lighting type LEDs 25, and an optical plate 20. The housing 21 includes a rectangular base 211 and four sidewalls 213 extending from a periphery of the base 211, the base 211 and the sidewalls 213 cooperatively forming an opening 215. The light diffusion plate 23 is disposed on the housing 21 over the opening 215. The optical plate 20, the light reflective plate 22, and the LEDs 25 are received in the housing 21.

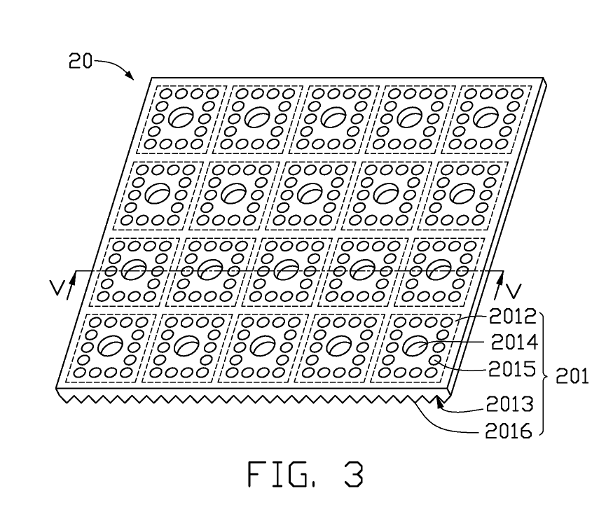

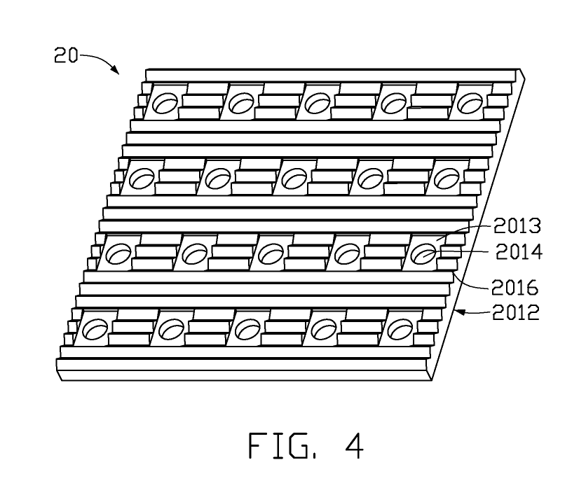

Referring to FIGS. 3 through 5, the optical plate 20 is a transparent square plate that can be fittingly mounted into the housing 21 correspondingly. The optical plate 20 includes a light output surface 2012 and a bottom surface 2013 opposite to the light output surface 2012. A plurality of spherical protrusions 2015 are formed on the light output surface 2012. A plurality of elongated V-shaped protrusions 2016 are formed on the bottom surface 2013. The optical plate 20 further includes a plurality of lamp-receiving portions 2014 defined in the bottom surface 2013. Each lamp-receiving portion 2014 is a through hole that communicates between the light output surface 2012 and the bottom surface 2013. In this embodiment, the optical plate 20 can be divided into twenty smaller square transparent plate sections 201 arranged side by side in a matrix manner. In each transparent plate section 201, each of the lamp-receiving portions 2014 is defined in a center of each of the transparent plate sections 201. The spherical protrusions 2015 are distributed on the light output surface 2012 surrounding the lamp-receiving portion 2014 on each of the transparent plate sections 201. The elongated V-shaped protrusions 2016 are distributed on the bottom surface 2013 except the lamp-receiving portion 2014 of each of the transparent plate sections 201. The spherical protrusions 2015 are distributed in a rectangular manner surrounding the lamp-receiving portion 2014 at the light output surface 2012.

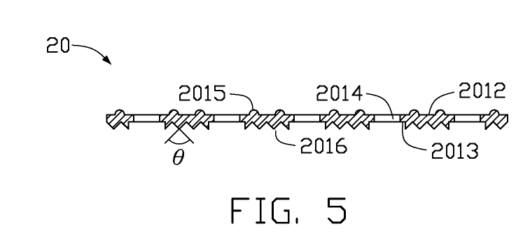

In this embodiment, a radius defined by each spherical protrusion 2015 is preferably in a range from about 0.01 millimeters to about 2 millimeters. A maximum height of each spherical protrusion 2015 is in a range from about 0.01 millimeters to about 2 millimeters. Each of the elongated V-shaped protrusions 2016 extends along a direction parallel to a side surface of the optical plate, and the elongated V-shaped protrusions 2016 connect with each other. Likewise, a pitch of two adjacent elongated V-shaped protrusions 2016 is configured to be in a range from about 0.025 millimeters to about 2 millimeters. Also referring to FIG. 5, a vertex angle θ of each of the elongated V-shaped protrusions 2016 is configured to be in a range from about 60 degrees to about 120 degrees.

The optical plate 20 can be made from material selected from the group consisting of polycarbonate (PC), polymethyl methacrylate (PMMA), polystyrene (PS), copolymer of methylmethacrylate and styrene (MS), and any suitable combination thereof. A thickness of the optical plate 20 is preferably in a range from 0.5 millimeters to about 5 millimeters.

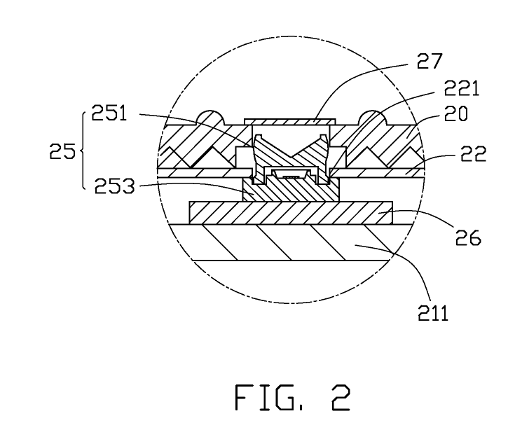

Referring to FIG. 2 again, each side-lighting type LED 25 includes a base portion 253 and a light-emitting portion 251 disposed on the base portion 253. The LEDs 25 are electrically connected to a printed circuit board 26 that is fixed to the base 211 of the housing 21. The light-emitting portion 251 of each LED 25 is inserted into a corresponding lamp-receiving portion 2014 of the optical plate 20, and the light output surface 2012 of the optical plate 20 faces the light diffusion plate 23. The light reflective plate 22 defines a plurality of through holes 221 corresponding to the lamp-receiving portions 2014 of the optical plate 20. The light reflective plate 22 is disposed underneath the bottom surface 2013 of the optical plate 20 with the light-emitting portions 251 of the LEDs 25 passing through the through holes 221 of the light reflective plate 22 correspondingly. The light reflective plate 22 and the optical plate 20 are supported by the base portions 253 of the LEDs 25.

In use, light emitted from the light-emitting portions 251 of the LEDs 25 enters the optical plate 20 via inner surfaces of the lamp-receiving portions 2014. A significant amount of the light is transmitted through the optical plate 20. Since the elongated V-shaped protrusions 2016 have a plurality of slanted side surfaces, a great amount of light can be directly reflected at the elongated V-shaped protrusions 2016, and the great amount of light quickly exits the light output surface 2012.

In addition, the spherical protrusions 2015 can condense and collimate light exiting from the light output surface 2012, thereby improving a light illumination brightness. Furthermore, because the side-lighting type LED 25 is positioned in the lamp-receiving portion 2014, light exits the light output surface 2012 uniformly. Light exiting the optical plate 20 can be further substantially mixed in a chamber between the optical plate 20 and the light diffusion plate 23, and before passing through the light diffusion plate 23 as uniform surface light. A distance from the LEDs 25 to the light diffusion plate 23 may be configured to be very small, with little or no potential risk of having dark areas on the portion of the backlight module 200 directly above the LEDs 25. Accordingly, the backlight module 200 can have a thin configuration while still providing good, uniform optical performance.

It should be pointed out that, the light reflective plate 22 can be omitted. In an alternative embodiment, a high reflectivity film can be deposited on inner surface of the base 211 and the sidewalls 213 of the housing 21. In other alternative embodiment, the housing 21 is made of metal materials, and has high reflectivity inner surfaces.

It is to be understood that, in order to further improve a light output optical performance of the backlight module 200 to be more uniform, the backlight module 200 can further include a reflective member 27 disposed over the light-emitting portion 251. Alternatively, a reflective member can be also disposed on the light-emitting portion 251 directly.

It is to be understood that, in order to improve a brightness of the backlight module 200 within a specific range of viewing angles, the backlight module 200 can further include a prism sheet 24 disposed on the light diffusion plate 23. In addition, in order to improve a light energy utilization rate of the backlight module 200, the light reflective plate 22 can further include four reflective sidewalls 223 extending around a periphery thereof and in contact with the sidewalls 213 of the housing 21.

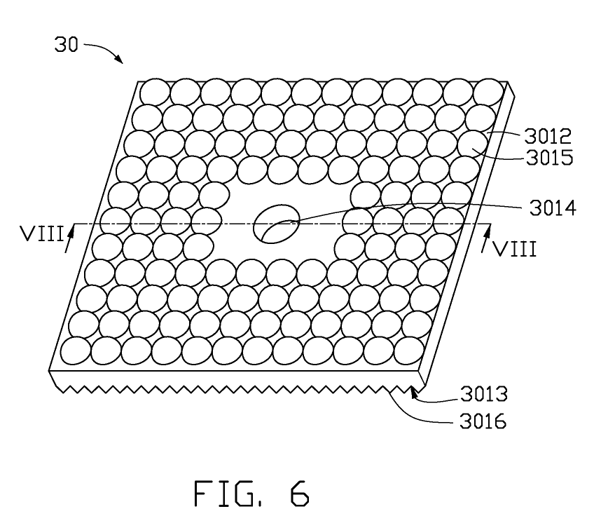

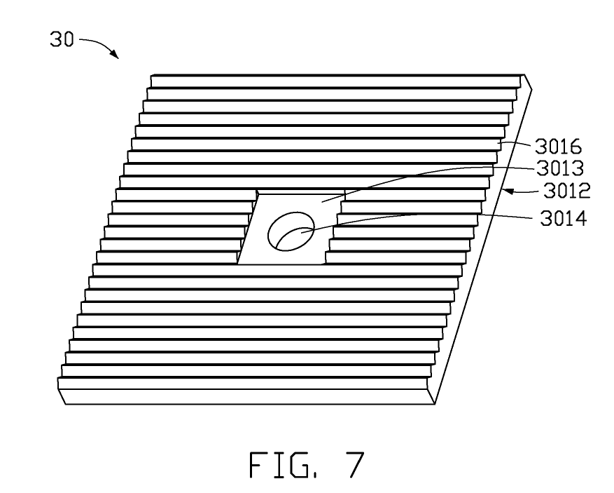

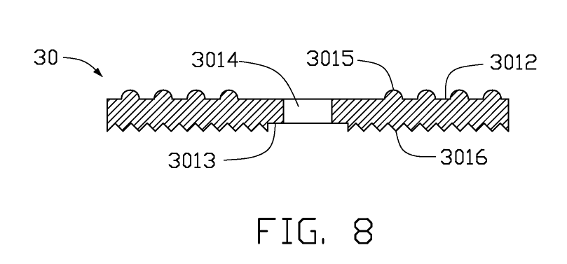

Referring to FIGS. 6 through 8, an optical plate 30 in accordance with a second preferred embodiment is shown. The optical plate 30 is similar in principle to the optical plate 20 of the first embodiment. However, only a lamp-receiving portion 3014 is defined in a center of optical plate 30 communicating between a light output surface 3012 and a bottom surface 3013. Further, a plurality of spherical protrusions 3015 are formed on the light output surface 3012 in a matrix manner except for a portion adjacent to the lamp-receiving portion 3014. A plurality of elongated V-shaped protrusions 3016 are formed on the bottom surface 3013 except for a portion adjacent to the lamp-receiving portion 3014. Each of the elongated V-shaped protrusions 3016 extends along a direction parallel to a side surface of the optical plate, and the elongated V-shaped protrusions 3016 connect with each other.

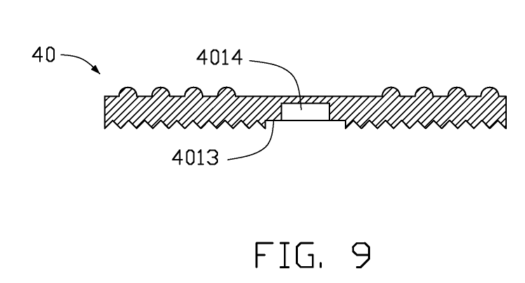

Referring to FIG. 9, an optical plate 40 in accordance with a third preferred embodiment is shown. The optical plate 40 is similar in principle to the optical plate 30, except that a lamp-receiving portion 4014 of the optical plate 40 is a blind hole. It should be pointed out that, a reflective layer can be deposited on a center of the optical plate 40 above the lamp-receiving portion 4014. Due to the reflective layer, a backlight module without an extra reflective member can be assembled.

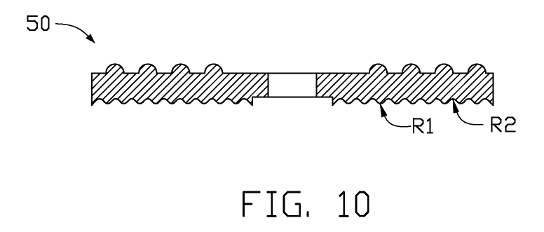

Referring to FIG. 10, an optical plate 50 in accordance with a fourth preferred embodiment is shown. The optical plate 50 is similar in principle to the optical plate 30, except that either vertex angles of the elongated V-shaped protrusions of the optical plate 50 or bottom angles defined by two adjacent elongated V-shaped protrusions of the optical plate 50 are rounded to form first round angles R1 and second round angles R2 respectively. Both the first round angle R1 and the second round angle R2 equal to or less than 1.1 millimeters, and great than zero.

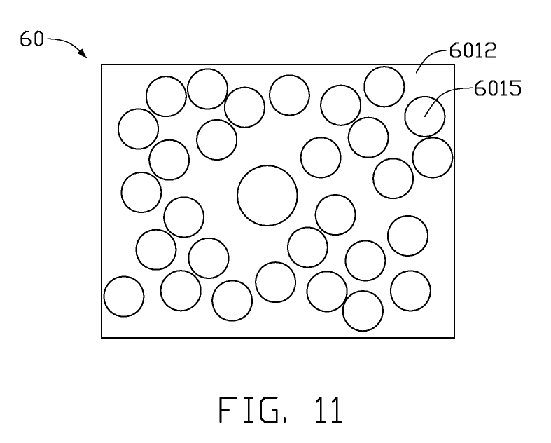

Referring to FIG. 11, an optical plate 60 in accordance with a fifth preferred embodiment is shown. The optical plate 60 is similar in principle to the optical plate 30, except that a plurality of spherical protrusions 6015 are randomly distributed on a light output surface 6012 randomly. It can be understood that spherical protrusions can be distributed symmetrically with respect to a lamp-received portion at a light output surface.

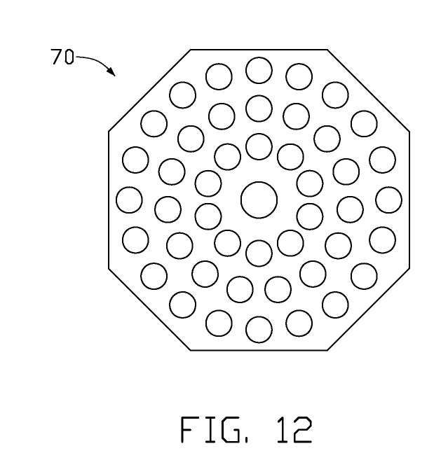

Referring to FIG. 12, an optical plate 70 in accordance with a sixth preferred embodiment is shown. The optical plate 70 is similar in principle to the optical plate 30, except that the optical plate 90 is an octagonal in shape.

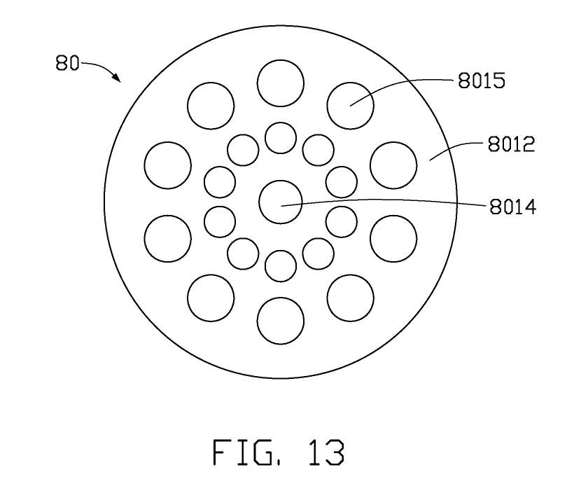

Referring to FIG. 13, an optical plate 80 in accordance with an seventh preferred embodiment is shown. The optical plate 80 is similar in principle to the optical plate 30, except that a plurality of spherical protrusions 8015 are formed on the light output surface 8012 surrounding a lamp-receiving portion 8014 and a size of each spherical protrusion 8015 increases along a direction far away from the lamp-receiving portion 8014. In this embodiment, a distance between a spherical protrusion 8015 and the lamp-receiving portion 8014 is greater, more light is adjusted by the spherical protrusion 8015. Thus, more uniform optical performance is achieved. In other alternative embodiment, if the sizes of the spherical protrusions 8015 are identical to each other, the same optical performance can be achieved by adjusting a density of spherical protrusions 8015 at varying distances from the lamp-receiving portion 8014.

It should be noted that, in the backlight module 200, not only the optical plate 20 can be positioned in the housing 21 with the light output surface 2012 facing the light diffusion plate 23, but can also be configured with the optical plate 20 be positioned in the housing 21 with the bottom surface 2013 facing the light diffusion plate 23. That is, the elongated V-shaped protrusions 2016 are formed on a first surface of the optical plate 20, and the spherical protrusions 2015 are formed on a second surface of the optical plate 20. The first surface is selected from one of the light output surface 2012 and the bottom surface 2013, and the second surface is selected from the other one of the light output surface 2012 and the bottom surface 2013. However, if a lamp-receiving portion is a blind hole, a surface where the blind hole is defined must be a bottom surface and the other surface must be a light output surface.

In the backlight module 200, a plurality of red, green, and blue colored LEDs can be inserted into the lamp-receiving portions 2014 of the optical plate 20, such that a blended white surface light can be obtained. It is to be understood that other kinds of point light source, such as field emission lamps and so on, can replace the LED 25 in above mentioned embodiments.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. An optical plate comprising:
at least one transparent plate section having:
a first surface;
a second surface opposite to the first surface;
a plurality of elongated V-shaped protrusions formed on the first surface;
a plurality of spherical protrusions formed on the second surface; and
at least a lamp-receiving portion defined in at least one of the first surface and the second surface.

2. The optical plate according to claim 1, wherein each of the elongated V-shaped protrusions extends along a direction parallel to a side surface of the optical plate, and the elongated V-shaped protrusions connect with each other.

3. The optical plate according to claim 1, wherein a pitch of the two adjacent elongated V-shaped protrusions is configured to be in a range from about 0.025 millimeters to about 2 millimeters.

4. The optical plate according to claim 1, wherein a vertex angle of each of the elongated V-shaped protrusions is configured to be in a range from about 60 degrees to about 120 degrees.

5. The optical plate according to claim 1, wherein at least one of vertex angles of the elongated V-shaped protrusions, and bottom angles defined by two adjacent elongated V-shaped protrusions, is rounded.

6. The optical plate according to claim 1, wherein the spherical protrusions are formed on the second surface in a matrix manner except the lamp-received portion.

7. The optical plate according to claim 1, a radius defined by each spherical protrusion is preferably in a range from about 0.01 millimeters to about 2 millimeters, a maximum height of each spherical protrusion is in a range from about 0.01 millimeters to about 2 millimeters.

8. The optical plate according to claim 1, a size of each spherical protrusion increases along a direction far away from the lamp-receiving portion.

9. The optical plate according to claim 1, wherein the lamp-receiving portion is selected from one of blind hole and through hole communicating between the first surface and the second surface.

10. The optical plate according to claim 1, wherein the optical plate includes a plurality of the transparent plate sections, the transparent plate sections being tightly combined with each other.

11. A backlight module comprising:
a housing having a base and a plurality of sidewalls extending from a periphery of the base, the base and the sidewalls cooperatively forming an opening;
at least one side-lighting type point light source disposed on the base, each point light source having a light-emitting portion;
an optical plate positioned in the housing, the optical plate including at least one transparent plate section having:
a first surface;
a second surface opposite to the first surface;
a plurality of elongated V-shaped protrusions formed on the first surface;
a plurality of spherical protrusions formed on the second surface; and
a lamp-receiving portion defined in at least one of the first surface and the second surface, wherein the light-emitting portion of the at least one point light source is inserted in the lamp receiving portion; and
a light diffusion plate disposed on the housing over the opening.

12. The backlight module according to claim 11, further comprising a light reflective plate defining a through hole therein, the light reflective plate being disposed underneath the bottom surface of the optical plate, and the light emitting potion of the point light source passing through the through hole of light reflective plate correspondingly.

13. The backlight module according to claim 12, wherein the light reflective plate further comprises a plurality of reflective sidewalls extending around a periphery thereof and contacting with the sidewalls of the housing.

14. The backlight module according to claim 11, wherein the housing is made of metal materials, and has high reflectivity inner surfaces.

15. The backlight module according to claim 11, further comprising a high reflectivity film deposited on inner surfaces of the base and the sidewalls of the housing.

16. The backlight module according to claim 11, further comprising a prism sheet disposed on the light diffusion plate.

17. The backlight module according to claim 11, wherein at least one of vertex angles of the elongated V-shaped protrusions, and bottom angles defined by two adjacent elongated V-shaped protrusions, is rounded.

18. The backlight module according to claim 11, wherein the lamp-receiving portion is selected from one of blind hole and through hole communicating with the first surface and the second surface.
